(19) United States
(12) Patent Application Publication
(10) Pub. No.: US 2026/0080440 A1
(43) Pub. Date: Mar. 19, 2026

(54) INFORMATION PROCESSING APPARATUS, INFORMATION PROCESSING SYSTEM, INFORMATION PROCESSING METHOD, AND COMPUTER PROGRAM PRODUCT FOR INFORMATION PROCESSING

(71) Applicant: GLORY LTD., Himeji-shi (JP)

(72) Inventors: Yukako GOTOU, Himeji-shi (JP); Soshi AOKI, Himeji-shi (JP)

(73) Assignee: GLORY LTD., Himeji-shi (JP)

(21) Appl. No.: 19/322,686

(22) Filed: Sep. 9, 2025

(30) Foreign Application Priority Data
Sep. 17, 2024 (JP) 2024-159915

(51) Int. Cl. G06Q 30/0251; G06V 40/16

(52) U.S. Cl. CPC G06Q 30/0269; G06Q 30/0261; G06Q 30/0268; G06V 40/168; G06V 40/172

(57) ABSTRACT

A face image of a customer A viewing an advertisement displayed on an advertisement display is captured by a camera, and a facial feature amount is acquired from the captured face image in a terminal device. A face image of a customer B purchased a commodity at a POS terminal is captured by a camera, and a facial feature amount is acquired from the captured face image in a terminal device. When it is determined that these customers are the same person based on comparison result of the facial feature amounts, the commodity viewed on the advertisement display and the commodity purchased at the POS terminal are specified. Then, it is determined whether these commodities are the same commodity. If the commodities are the same commodity, it is determined that the advertisement display is effective.

### CROSS-REFERENCE TO RELATED APPLICATION

The present application is a continuation of, and claims priority to, Japanese patent application JP 2024-159915 filed Sep. 17, 2024, the entire contents of which is incorporated herein by reference.

### TECHNICAL FIELD

The present disclosure relates to an information processing apparatus, an information processing system, an information processing method, and a computer program product for information processing, for analyzing relationship between a viewer of an advertisement of a commodity and a purchased commodity by the viewer.

### BACKGROUND ART

Conventionally, a technology for analyzing the effect of a signage advertisement performed at a store, on the purchase behaviors of customers, has been known. For example, Japanese Patent Nos. 5711364 and 4666304 disclose related technologies. A camera installed with a device for the signage advertisement is used for capturing a face image of a customer who views an advertisement. Another camera installed with a POS register is used for capturing a face image of a customer who purchases a commodity. Face feature amounts extracted from these face images are compared with each other to link advertisement viewing history data with purchase data. Then, using the data, the percentage of customers who viewed the advertisement and purchased the advertised commodity is calculated to determine the advertisement viewing effect on the customer's purchase behavior.

### SUMMARY

If a device for the digital signage advertisement includes a built-in camera, the device can acquire an image of a viewer and associate the image with data of a commodity in the advertisement viewed by the viewer. Meanwhile, if the device does not include the built-in camera, it is necessary to provide the device with an interface for an external camera, connect the device to the external camera, and collect data in the device from the external camera.

The present disclosure has been made in view of the problem, as well as other problems, of the conventional art, and the present disclosure addresses these issues, as discussed herein, with an information processing apparatus, an information processing system, an information processing method, and a computer program product for information processing, for analyzing relationship between a viewer of an advertisement performed at a store for a commodity and a purchased commodity by the viewer, even in a case where the advertisement is displayed by using a display installed in the store and the viewer is captured by using an external imaging device installed separated from the display.

An information processing apparatus according to one aspect of the present disclosure includes: a person information acquisition unit configured to acquire person information including feature information of a person who is present near a display for displaying a commodity advertisement and satisfies a predetermined condition and information on a time at which the person is present near the display device; a purchaser information acquisition unit configured to acquire purchaser information including feature information of a purchaser who purchases a commodity and information on a purchase time at which a purchase action of the purchaser is detected; an association unit configured to compare the feature information of the person with the feature information of the purchaser, and associate the person information with the purchaser information of the same person; a memory configured to store therein information on a display time for each commodity advertisement, at which the commodity advertisement is displayed on the display; a viewed commodity specification unit configured to specify a viewed commodity whose commodity advertisement is presumed to be viewed by the person, based on the person information and the display time; a commodity sales information acquisition unit configured to acquire commodity sales information including a sales commodity and sales time; a purchased commodity specification unit configured to specify a commodity purchased by the purchaser, based on the purchaser information and the commodity sales information; and a determination unit configured to specify the purchased commodity and the viewed commodity corresponding to the same person, based on correspondence between the person information and the purchaser information, and determine whether the person has purchased the viewed commodity, based on a result of comparison between the viewed commodity and the purchased commodity.

### BRIEF DESCRIPTION OF THE DRAWINGS

FIG. 1 illustrates an outline of an information processing system;

FIG. 2 shows a system configuration of the information processing system;

FIG. 3 is a function block diagram showing a configuration of a terminal device disposed near an advertisement display shown in FIG. 2;

FIG. 4 shows an example of ID data shown in FIG. 3;

FIG. 5 is a function block diagram showing a configuration of a terminal device disposed near a POS terminal shown in FIG. 2;

FIGS. 6A to 6C show examples of ID data, viewer data, and purchaser data shown in FIG. 5;

FIG. 7 shows a function block diagram showing a configuration of an information processing apparatus shown in FIG. 2;

FIGS. 8A to 8C show examples of program table data, sales commodity data, and viewer attribute data shown in FIG. 7;

FIGS. 9A to 9C show examples of purchaser attribute data, comparison data, and viewed commodity data shown in FIG. 7;

FIGS. 10A and 10B show examples of purchased commodity data and determination data shown in FIG. 7;

FIG. 11 shows an example of analysis data shown in FIG. 7;

FIG. 12 is a function block diagram showing a configuration of an advertisement display shown in FIG. 2;

FIG. 13 is a flowchart showing procedures relating to advertisement effect determination; and

FIG. 14 shows an example of a hardware configuration of the information processing apparatus.

### DESCRIPTION OF EMBODIMENT

Hereinafter, an embodiment of an information processing apparatus, an information processing system, an information processing method, and a computer program product for information processing according to the present disclosure will be described in detail with reference to the drawings.

### Outline of Information Processing System

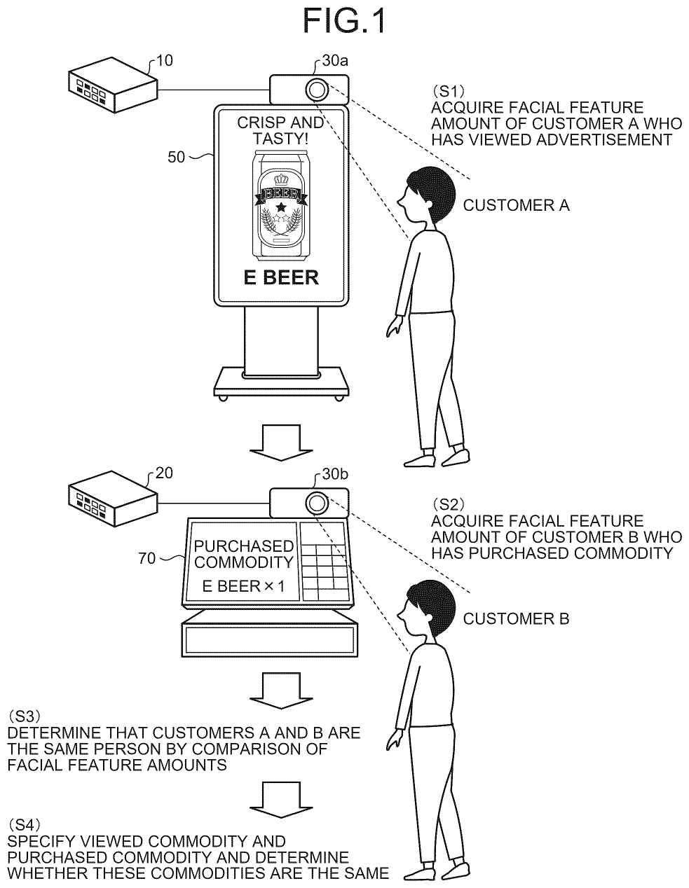

First, an outline of an information processing system will be described. FIG. 1 illustrates the outline of the information processing system.

As shown in FIG. 1, a face image of a customer A who has viewed an advertisement displayed on an advertisement display 50 is captured by a camera 30a, and a facial feature amount is acquired from the captured face image in a terminal device 10 (S1).

When a customer B purchases a commodity at a POS terminal 70, a face image of the customer B is captured by a camera 30b, and a facial feature amount is acquired from the captured face image in a terminal device 20 (S2).

The facial feature amounts of the customer A and the customer B are compared with each other. When it is determined that these customers A and B are the same person (S3), the commodity viewed by the customer on the advertisement display 50 and the commodity purchased by the customer at the POS terminal 70 are specified. Then, it is determined whether these commodities are the same (S4). If the commodities are the same, it can be determined that the advertisement display is effective.

As described above, in the information processing system, a facial feature amount is acquired from an image obtained by capturing a customer viewing an advertisement displayed on the advertisement display, with the external imaging device, and another facial feature amount is acquired from another image obtained by capturing a customer purchasing a commodity, with another external imaging device. If the customers are determined to be the same person by comparing the facial feature amounts thereof, and the commodity advertised in the viewed advertisement and the purchased commodity are the same, it is determined that the displayed advertisement is effective. When a customer who views a commodity advertisement displayed on the display installed in the store is captured by using the external imaging device, the purchase status of the advertised commodity by the viewer of the advertisement can be grasped.

### System Configuration of Information Processing System

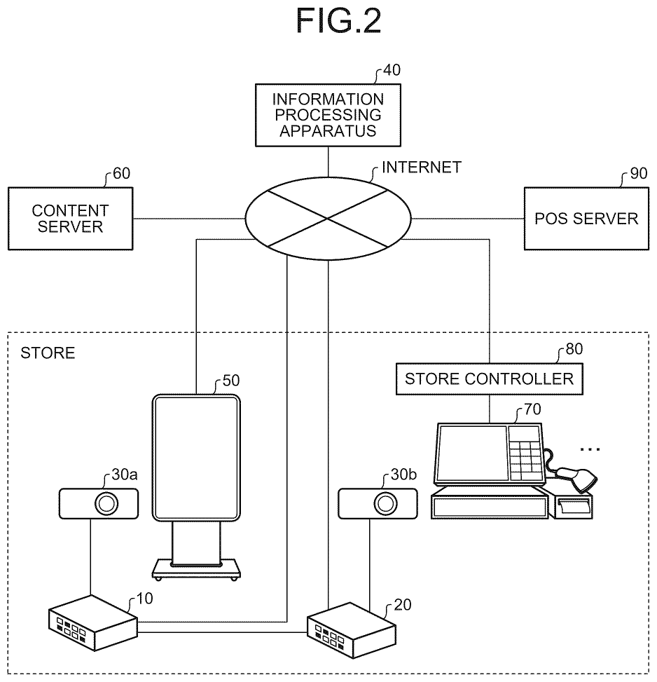

The system configuration of the information processing system will be described. FIG. 2 shows the system configuration of the information processing system.

As shown in FIG. 2, an advertisement display 50 and POS terminals 70 are installed in a store. A camera 30a and a terminal device 10 are disposed near the advertisement display 50. A camera 30b and a terminal device 20 are disposed near each POS terminal 70. Communications from a plurality of POS terminals 70 are performed via a store controller 80.

The camera 30a and the terminal device 10, the camera 30b and the terminal device 20, and the terminal device 10 and the terminal device 20 are each communicably connected.

The terminal device 10, the terminal device 20, the advertisement display 50, and the store controller 80 are connected to the Internet. Also, an information processing apparatus 40, a content server 60, and a POS server 90 are connected to the Internet.

The information processing apparatus 40 is communicably connected to the terminal device 10, the terminal device 20, the content server 60, and the POS server 90 via the Internet. The content server 60 is communicably connected to the advertisement display 50 and the information processing apparatus 40 via the Internet. The POS server 90 is communicably connected to the store controller 80 and the information processing apparatus 40 via the Internet.

The content server 60 is a device that manages information on commodity advertisements to be displayed on the advertisement display 50. The content server 60 receives advertisement information including a program table and advertisement images of commodity advertisements to be displayed on the advertisement display 50. The content server 60 provides the advertisement display 50 with the advertisement information (including the program table). Also, the content server 60 provides the information processing apparatus 40 with the program table.

The advertisement display 50 is a display device for displaying advertisements of commodities. The advertisement display 50 may be a device used for digital signage. Upon receiving the advertisement information from the content server 60, the advertisement display 50 displays an advertisement image, based on the program table included in the advertisement information.

The POS terminal 70 is a terminal that performs a settlement process for commodities purchased by customers. The POS terminal 70 receives, by using a barcode reader or the like, information on commodities purchased by a customer, and then receives money from the customer to perform the settlement process. When the settlement process is completed, the POS terminal 70 notifies the store controller 80 of sales commodity information including the names and the number of sold commodities, the sales amount, the transaction date and time (sales time), the commodity category, and the POS terminal ID. The transaction date and time included in the sales commodity information may be the time when the customer or the store clerk registered the first commodity at the cash register by scanning the bar code, the time when the customer performed the settlement process for the commodities at the cash register, the time when the customer operated the POS terminal 70 to start transaction to purchase the commodity, or the time when the clerk completed registration for all the commodities purchased by the customer.

The store controller 80 is a relay device that receives information from the plurality of POS terminals 70 and transmits the received information to the POS server 90. Upon receiving the sales commodity information from a POS terminal 70, the store controller 80 adds the store ID to the sales commodity information, and transmits it to the POS server 90.

The POS server 90 is a device that manages the sales commodity information received from all the POS terminals 70. Upon receiving the sales commodity information from the store controller 80, the POS server 90 stores the sales commodity information in a memory, and transmits it to the information processing apparatus 40.

The camera 30a is an imaging device disposed near the advertisement display 50. The camera 30a captures an area near the front of the advertisement display 50, and transmits captured video to the terminal device 10.

The camera 30b is an imaging device disposed near the POS terminal 70. The camera 30b captures an area near the front of the POS terminal 70, and transmits captured video to the terminal device 20.

The terminal device 10 is a device that extracts a facial feature amount of the customer who views the commodity advertisement displayed on the advertisement display 50. Using the video received from the camera 30a, the terminal device 10 detects the customer viewing the advertisement image on the advertisement display 50, and then starts recording of video data. When the customer stops viewing the advertisement image or moves out of the imaging range of the camera 30a, the terminal device 10 ends recording of the video data.

The terminal device 10 extracts a facial feature amount from the face image of the customer captured in the stored video data, and determines the attribute of the customer by using the facial feature amount. The terminal device 10 generates a unique signage facial feature amount ID. The terminal device 10 transmits the signage facial feature amount ID and the facial feature amount, as viewer data, to the terminal device 20. Furthermore, the terminal device 10 transmits the store ID, the signage ID, the signage facial feature amount ID, recording start time and end time of video data 15b, and the attribute, as viewer attribute data, to the information processing apparatus 40. Thereafter, the terminal device 10 deletes the video data.

The terminal device 20 is a device that extracts a facial feature amount of a customer who operates the POS terminal 70. The terminal device 20 performs matching determination between a viewer of an advertisement image and a purchaser of a commodity. When the terminal device 20 has detected a customer who stays near the POS terminal 70 for a certain time, by using the video received from the camera 30b, the terminal device 20 starts recording of video data. The terminal device 20 ends recording of the video data when the customer has moved out of the imaging range of the camera 30b. The video data recording may start when it is detected that a customer is operating the POS terminal 70.

The terminal device 20 extracts a facial feature amount from the face image of the customer captured in the stored video data by using the camera 30b, and determines the attribute of the customer by using the facial feature amount. The terminal device 20 generates a unique register facial feature amount ID. The terminal device 20 stores the register facial feature amount ID and the facial feature amount, as purchaser data. The terminal device 20 transmits the store ID, the POS terminal ID, the register facial feature amount ID, recording start time and end time of video data, and the attribute, as purchaser attribute data, to the information processing apparatus 40. Then, the terminal device 20 deletes the video data.

The terminal device 20 compares the facial feature amount in the purchaser data with the facial feature amount in the viewer data received from the terminal device 10 to determine whether the purchaser and the viewer are the same person. When the purchaser and the viewer are the same person, the terminal device 20 transmits the signage facial feature amount ID, the register facial feature amount ID, the store ID, and the determination result, as comparison data, to the information processing apparatus 40. All the acquired data may be transmitted to a higher-order device, and the higher-order device may determine whether the purchaser and the viewer are the same person and may determine matching of the purchased commodity. For example, the information processing apparatus 40 may perform the determinations.

The information processing apparatus 40 is an apparatus that determines whether a commodity that a customer has viewed on the advertisement display 50 is the same as a commodity that the customer has purchased, and analyzes the advertisement effect from the determination result. Upon receiving the program table from the content server 60, the sales commodity information from the POS server 90, the viewer attribute data from the terminal device 10, and the purchaser attribute data and the comparison data from the terminal device 20, the information processing apparatus 40 stores the respective data in the memory, as program table data, sales commodity data, viewer attribute data, purchaser attribute data, and comparison data.

If the viewer attribute data is updated, the information processing apparatus 40 specifies, from the program table data, the advertisement commodity name that matches the updated data, and stores the same as viewed commodity data. If the purchaser attribute data is updated, the information processing apparatus 40 specifies, from the sales commodity data, the sold commodity name that matches the updated data, and stores the same as purchased commodity data.

If the comparison data is updated, the information processing apparatus 40 specifies the viewed commodity name and the purchased commodity name corresponding to the updated data, from the viewed commodity data and the purchased commodity data, respectively. If the specified viewed commodity name and the specified purchased commodity name match, it is determined that the advertisement is effective. If there is no match, it is determined that the advertisement is ineffective. The determination result is stored as determination data.

The information processing apparatus 40 calculates the probability (hereinafter referred to as “purchase rate”) that the advertisement effect determination is “effective” for each viewed commodity name, by using the determination data at a predetermined period (e.g., end of each month). The information processing apparatus 40 calculates the purchase rate by attribute, and the purchase rate by time slot of viewing date and time. The calculated purchase rates are stored in the analysis data. The base number for the purchase rate is the number of persons (hereinafter referred to as “viewers”) who have viewed a commodity advertisement displayed on the advertisement display 50. The base number for the purchase rate by attribute is the number of viewers of a specific age or a specific gender. The base number for the purchase rate by viewing time slot is the number of viewers in a specific viewing time period.

### Configuration of Terminal Device 10

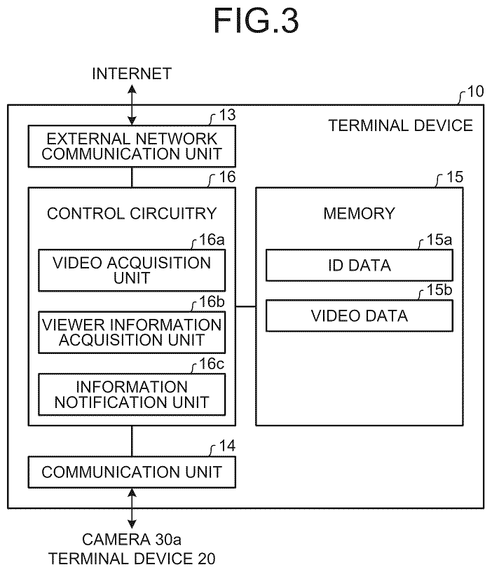

The configuration of the terminal device 10 disposed near the advertisement display 50 shown in FIG. 2 will be described. FIG. 3 is a function block diagram showing the configuration of the terminal device 10 disposed near the advertisement display 50 shown in FIG. 2. As shown in FIG. 3, the terminal device 10 includes an external network communication unit 13, a communication unit 14, a memory 15, and a control circuitry 16.

The external network communication unit 13 is an interface unit for data communication with the information processing apparatus 40 via the Internet. The communication unit 14 is an interface unit for data communication with the camera 30a and the terminal device 20.

The memory 15 is a storage device such as a hard disk device or a non-volatile memory, and stores therein ID data 15a and video data 15b. The ID data 15a is data indicating the store ID of the store and the signage ID of the advertisement display 50. The video data 15b is data of video captured by the camera 30a.

The control circuitry 16 performs overall control for the terminal device 10. The control circuitry 16 includes a video acquisition unit 16a, a viewer information acquisition unit 16b, and an information notification unit 16c. In actuality, programs for these units are loaded to a CPU (Central Processing Unit) and executed, whereby processes corresponding to the video acquisition unit 16a, the viewer information acquisition unit 16b, and the information notification unit 16c are performed.

The video acquisition unit 16a is a processing unit that acquires video captured by the camera 30a, and manages the video data 15b. The video acquisition unit 16a receives the video from the camera 30a, and starts storage of the received video into the video data 15b, upon determining that the customer captured in the received video is viewing an advertisement image on the advertisement display 50. If this customer stops viewing the advertisement image or moves out of the imaging range of the camera 30a, the video acquisition unit 16a ends the storage of the received video into the video data 15b. Whether the customer is viewing the advertisement image is determined based on the direction of the customer's face and/or line of sight.

The viewer information acquisition unit 16b is a processing unit that acquires the facial feature amount and the attribute of the customer viewing the advertisement image on the advertisement display 50. When the video data 15b is updated by the video acquisition unit 16a, the viewer information acquisition unit 16b extracts the facial feature amount from the face image of the customer captured in the video data 15b, and determines the customer's gender and age (generation) by using the facial feature amount. Then, a unique signage facial feature amount ID is generated.

The facial feature amount is data obtained by quantifying the facial features to be used in face recognition technology. Specifically, the facial feature amount includes various features of the face, such as face shape, expression, skin color, eye position, nose shape, mouth shape, etc., which are measured and expressed as numerical values.

The information notification unit 16c is a processing unit that notifies the facial feature amount and the attribute of the viewer of the advertisement image. When the facial feature amount, the attribute, and the signage facial feature amount ID of the viewer of the advertisement image are acquired or generated by the viewer information acquisition unit 16b, the information notification unit 16c performs the following processing.

The information notification unit 16c transmits the signage facial feature amount ID and the facial feature amount, as viewer data, to the terminal device 20. The information notification unit 16c transmits, as viewer attribute data, the store ID and the signage ID in the ID data 15a, the signage facial feature amount ID, the recording start time and end time of the video data 15b, and the attribute, to the information processing apparatus 40.

After transmission of the viewer data and the viewer attribute data is completed, the information notification unit 16c deletes the data stored in the video data 15b.

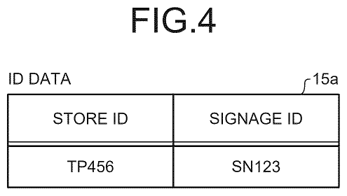

Next, an example of data stored in the memory 15 of the terminal device 10 shown in FIG. 3 will be described. FIG. 4 shows an example of the ID data 15a shown in FIG. 3. The ID data 15a shown in FIG. 4 indicates that the store ID is “TP456” and the signage ID is “SN123”.

### Configuration of Terminal Device 20

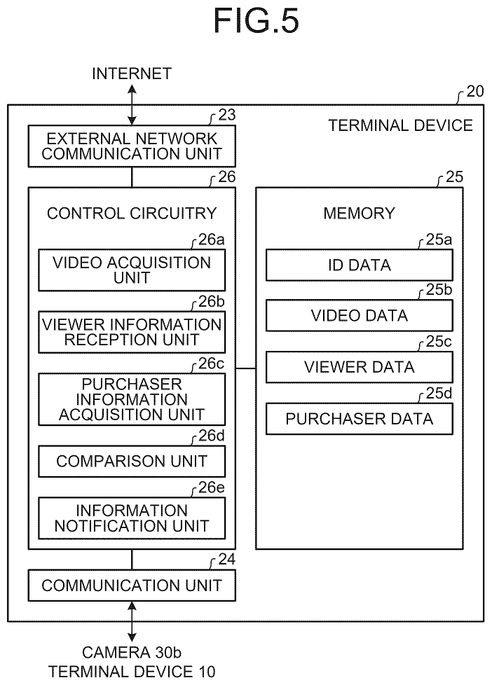

The configuration of the terminal device 20 disposed near the POS terminal 70 shown in FIG. 2 will be described. FIG. 5 is a function block diagram showing the configuration of the terminal device 20 disposed near the POS terminal 70 shown in FIG. 2. As shown in FIG. 5, the terminal device 20 includes an external network communication unit 23, a communication unit 24, a memory 25, and a control circuitry 26.

The external network communication unit 23 is an interface unit for data communication with the information processing apparatus 40 via the Internet. The communication unit 24 is an interface unit for data communication with the camera 30b and the terminal device 10.

The memory 25 is a storage device such as a hard disk device or a non-volatile memory, and stores therein ID data 25a, video data 25b, viewer data 25c, and purchaser data 25d.

The ID data 25a is data indicating the store ID of the store and the POS terminal ID of the POS terminal 70. The video data 25b is data of video captured by the camera 30b. The viewer data 25c is data including the facial feature amount of a customer who has viewed an advertisement on the advertisement display 50. The purchaser data 25d is data including the facial feature amount of the customer who has purchased a commodity at the POS terminal 70.

The control circuitry 26 performs overall control for the terminal device 20. The control circuitry 36 includes a video acquisition unit 26a, a viewer information reception unit 26b, a purchaser information acquisition unit 26c, a comparison unit 26d, and an information notification unit 26e. In actuality, programs for these units are loaded to a CPU and executed, whereby processes corresponding to the video acquisition unit 26a, the viewer information reception unit 26b, the purchaser information acquisition unit 26c, the comparison unit 26d, and the information notification unit 26e are performed.

The video acquisition unit 26a is a processing unit that acquires video captured by the camera 30b, and manages the video data 25b. The video acquisition unit 26a receives the video from the camera 30b, and starts storage of the received video into the video data 25b when the customer operating the POS terminal 70 is captured in the received video. Then, if the customer moves out of the imaging range of the camera 30b, the video acquisition unit 26a ends the storage of the received video into the video data 25b.

The viewer information reception unit 26b is a processing unit that receives viewer data from the terminal device 10. Upon receiving the viewer data from the terminal device 10, the viewer information reception unit 26b stores the received data into the viewer data 25c to update the viewer data 25c.

The purchaser information acquisition unit 26c is a processing unit that acquires the facial feature amount and the attribute of the customer operating the POS terminal 70. When the video data 25b is updated by the video acquisition unit 26a, the purchaser information acquisition unit 26c extracts the facial feature amount from the face image of the customer captured in the video data 25b, and determines the customer's gender and age (generation) by using the facial feature amount. Then, the purchaser information acquisition unit 26c generates a unique register facial feature amount ID.

After generation of the register facial feature amount ID and extraction of the facial feature amount, the purchaser information acquisition unit 26c stores the register facial feature amount ID and the facial feature amount into the purchaser data 25d.

The comparison unit 26d is a processing unit that performs matching determination between the viewer of the advertisement image and the purchaser of the commodities. When the purchaser data 25d is updated by the purchaser information acquisition unit 26c, the comparison unit 26d compares the facial feature amount in the purchaser data 25d with all the facial feature amounts in the viewer data 25c to determine whether the viewer and the purchaser are the same person. When comparison with all the facial feature amounts in the viewer data 25c is ended, the data stored in the purchaser data 25d is deleted.

The information notification unit 26e is a processing unit that notifies the attribute of the commodity purchaser and the comparison result. When the attribute of the commodity purchaser is determined by the purchaser information acquisition unit 26c, the information notification unit 26e transmits, as purchaser attribute data, the store ID and the POS terminal ID in the ID data 25a, the register facial feature amount ID, the recording start time and end time of the video data 25b, and the attribute, to the information processing apparatus 40. Then, the information notification unit 26e deletes the data stored in the video data 25b.

When the viewer and the purchaser are determined to be the same person by the purchaser information acquisition unit 26c, the information notification unit 26e transmits, as comparison data, the signage facial feature amount ID in the viewer data 25c and the register facial feature amount ID in the viewer data 25c, the store ID in the ID data 25a, and the determination result, at the time of this determination, to the information processing apparatus 40.

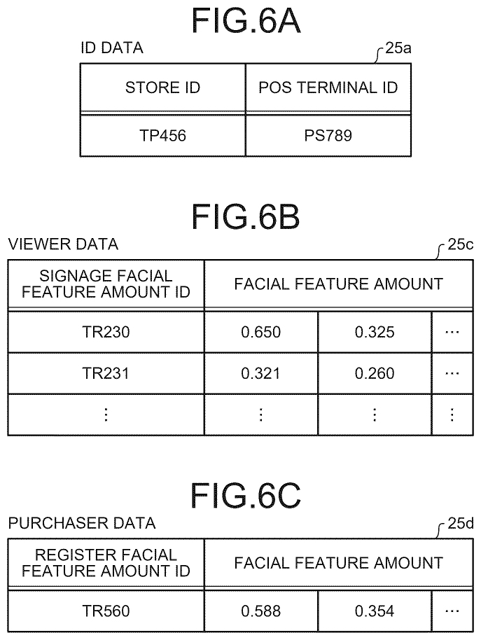

Next, an example of data stored in the memory 25 of the terminal device 20 shown in FIG. 5 will be described. FIGS. 6A to 6C show examples of the ID data 25a, the viewer data 25c, and the purchaser data 25d shown in FIG. 5.

The ID data 25a shown in FIG. 6A indicates that the store ID is “TP456” and the POS terminal ID is “PS789”.

In the viewer data 25c shown in FIG. 6B, the signage facial feature amount ID “TR230” is associated with the state where the facial feature amounts are “0.650” and “0.325”, and the signage facial feature amount ID “TR231” is associated with the state where the facial feature amounts are “0.321” and “0.260”.

In the purchaser data 25d shown in FIG. 6C, the register facial feature amount ID “TR560” is associated with the state where the facial feature amounts are “0.588” and “0.354”.

### Configuration of Information Processing Apparatus 40

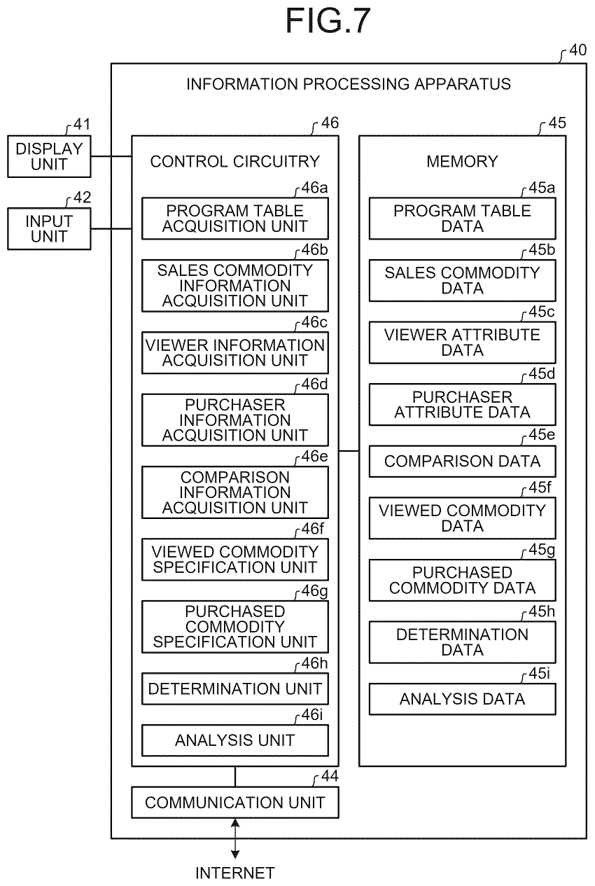

The configuration of the information processing apparatus 40 shown in FIG. 2 will be described. FIG. 7 is a function block diagram showing the configuration of the information processing apparatus 40 shown in FIG. 2. As shown in FIG. 7, the information processing apparatus 40 includes a display unit 41, an input unit 42, a communication unit 44, a memory 45, and a control circuitry 46.

The display unit 41 is a display device such as a liquid crystal panel. The input unit 42 is an input device such as a keyboard and a mouse. The communication unit 44 is an interface unit for data communication with the terminal device 10, the terminal device 20, the content server 60, and the POS server 90 via the Internet.

The memory 45 is a storage device such as a hard disk device or a non-volatile memory, and stores therein program table data 45a, sales commodity data 45b, viewer attribute data 45c, purchaser attribute data 45d, comparison data 45e, viewed commodity data 45f, purchased commodity data 45g, determination data 45h, and analysis data 45i.

The program table data 45a is data indicating a program table of commodity advertisements to be displayed on the advertisement display 50. The sales commodity data 45b is data indicating information on commodities sold at the POS terminal 70.

The viewer attribute data 45c is data indicating information on customers who viewed commodity advertisements displayed on the advertisement display 50. The purchaser attribute data 45d is data indicating information on customers who purchased commodities at the POS terminal 70.

The comparison data 45e is data indicating the result of comparison of facial feature amounts of a customer who viewed a commodity advertisement and a customer who purchased a commodity. The viewed commodity data 45f is data indicating commodities whose advertisements are viewed on the advertisement display 50 by customers. The purchased commodity data 45g is data indicating commodities purchased at the POS terminal 70 by customers.

The determination data 45h is data indicating the result of determination for the effect of the commodity advertisement obtained by comparing a commodity viewed by a customer with a commodity purchased by the customer. The analysis data 45i is data indicating the purchase rates, etc., of advertised commodities.

The control circuitry 46 performs overall control for the information processing apparatus 40. The control circuitry 46 includes a program table acquisition unit 46a, a sales commodity information acquisition unit 46b, a viewer information acquisition unit 46c, a purchaser information acquisition unit 46d, a comparison information acquisition unit 46e, a viewed commodity specification unit 46f, a purchased commodity specification unit 46g, a determination unit 46h, and an analysis unit 46i. In actuality, programs for these units are loaded to a CPU and executed, whereby processes corresponding to the program table acquisition unit 46a, the sales commodity information acquisition unit 46b, the viewer information acquisition unit 46c, the purchaser information acquisition unit 46d, the comparison information acquisition unit 46e, the viewed commodity specification unit 46f, the purchased commodity specification unit 46g, the determination unit 46h, and the analysis unit 46i are performed.

The program table acquisition unit 46a is a processing unit that manages the program table data 45a. Upon receiving a program table from the content server 60, the program table acquisition unit 46a stores the program table into the program table data 45a.

The sales commodity information acquisition unit 46b is a processing unit that manages the sales commodity data 45b. Upon receiving sales commodity information from the POS server 90, the sales commodity information acquisition unit 46b stores the sales commodity information into the sales commodity data 45b.

The viewer information acquisition unit 46c is a processing unit that manages the viewer attribute data 45c. Upon receiving viewer attribute data from the terminal device 10, the viewer information acquisition unit 46c stores the viewer attribute data into the viewer attribute data 45c.

The purchaser information acquisition unit 46d is a processing unit that manages the purchaser attribute data 45d. Upon receiving purchaser attribute data from the terminal device 20, the purchaser information acquisition unit 46d stores the purchaser attribute data into the purchaser attribute data 45d.

The comparison information acquisition unit 46e is a processing unit that manages the comparison data 45e. Upon receiving comparison data from the terminal device 20, the comparison information acquisition unit 46e stores the comparison data into the comparison data 45e.

The viewed commodity specification unit 46f is a processing unit that specifies the commodity viewed by the customer and manages the viewed commodity data 45f. When the viewer attribute data 45c is updated by the viewer information acquisition unit 46c, the viewed commodity specification unit 46f extracts the signage ID, the signage facial feature amount ID, the viewing start time, and the viewing end time, from the updated data, and performs the following processing.

The viewed commodity specification unit 46f specifies, from the program table data 45a, an advertised commodity name that matches the extracted data. Specifically, data that matches the extracted signage ID and pertains to distribution of an advertisement during a time slot from the viewing start time to the viewing end time is extracted from the program table data 45a, and an advertised commodity name corresponding to this data is specified as a viewed commodity.

The specified commodity name is associated with the store ID and the signage facial feature amount ID extracted from the data updated in the viewer attribute data 45c, and these data are stored in the viewed commodity data 45f.

The purchased commodity specification unit 46g is a processing unit that specifies the commodity purchased by the customer, and manages the purchased commodity data 45g. When the purchaser attribute data 45d is updated by the purchaser information acquisition unit 46d, the purchased commodity specification unit 46g extracts the store ID, the POS terminal ID, the register facial feature amount ID, the detection start time, and the detection end time, from the updated data, and performs the following processing.

The purchased commodity specification unit 46g specifies, from the sales commodity data 45b, the commodity name that matches the extracted data. Specifically, data that matches the extracted store ID and POS terminal ID and pertains to a transaction performed during a time slot from the detection start time to the detection end time (data in which the transaction date and time is included in the time slot from the detection start time to the detection end time), is extracted from the sales commodity data 45b, and the commodity name corresponding to this data is specified as the purchased commodity.

The specified commodity name is associated with the store ID and the register facial feature amount ID extracted from the data updated in the purchaser attribute data 45d, and these data are stored in the purchased commodity data 45g.

The determination unit 46h is a processing unit that determines whether the commodity viewed by the customer and the commodity purchased by the customer are the same commodity, and manages the determination data 45h. When the comparison data 45e is updated by the comparison information acquisition unit 46e, the determination unit 46h extracts the store ID, the signage facial feature amount ID, and the register facial feature amount ID from the updated data, and performs the following processing.

The viewed commodity name corresponding to the extracted store ID and signage facial feature amount ID is specified from the viewed commodity data 45f, and the purchased commodity name corresponding to the extracted store ID and register facial feature amount ID is specified from the purchased commodity data 45g. Then, if the specified viewed commodity name matches the specified purchased commodity name, it is determined that the advertisement is effective. If there is no match, it is determined that the advertisement is ineffective.

When the advertisement effect has been determined, the customer attribute, the viewed commodity name, presence/absence of viewing, presence/absence of purchase, the purchased commodity name, the viewing time, the signage facial feature amount ID, the register facial feature amount ID, the transaction date and time, and determination result of the advertisement effect are stored in the determination data 45h in association with each other. The contents of the respective items to be stored are as follows.

As for the customer attribute, an attribute corresponding to the store ID and the register facial feature amount ID in the data updated in the comparison data 45e is specified from the purchaser attribute data 45d. As for the viewed commodity name, a viewed commodity name corresponding to the store ID and the signage facial feature amount ID in the data updated in the comparison data 45e is specified from the viewed commodity data 45f.

The presence/absence of viewing and the presence/absence of purchase become both “present”. In the present embodiment, when the customer has viewed a commodity advertisement, the viewer attribute data 45c is received from the terminal device 10, and when the customer has purchased a commodity, the purchaser attribute data 45d is received from the terminal device 20. Therefore, the presence/absence of viewing and the presence/absence of purchase are both “present”. On the other hand, in a case where the viewer attribute data 45c is received from the terminal device 10 even if the customer has not viewed the commodity advertisement or in a case where the customer stored in the viewer attribute data 45c is not stored in the purchaser attribute data 45d, the presence/absence of viewing and the presence/absence of purchase each may be “present” or “absent” according to the situation.

As for the purchased commodity name, a purchased commodity name corresponding to the store ID and the register facial feature amount ID in the data updated in the comparison data 45e is specified from the purchased commodity data 45g. As for the viewing time, the viewing start time and end time corresponding to the store ID and the signage facial feature amount ID in the data updated in the comparison data 45e are specified from the viewer attribute data 45c, and the time slot between the start and end times is used. As for the transaction date and time, the transaction date and time corresponding to the data in the sales commodity data 45b specified in the purchased commodity specification unit 46g is used.

The analysis unit 46i is a processing unit that analyzes the advertisement effect through predetermined processing, and manages the analysis data 45i. At a predetermined period (e.g., end of each month), the analysis unit 46i performs the following processing for each viewed commodity name by using the determination data 45h.

The analysis unit 46i calculates the purchase rate at which the advertisement effect determination is “effective”. In addition, the analysis unit 46i calculates the purchase rate by attribute. The purchase rate by attribute is calculated by gender and by age (e.g., teens, 20s, 30s, etc.). In addition, the analysis unit 46i calculates the purchase rate by viewing time slot. For example, this purchase rate is calculated every two hours after the opening of the store. Then, the calculated purchase rates are stored in the analysis data 45i.

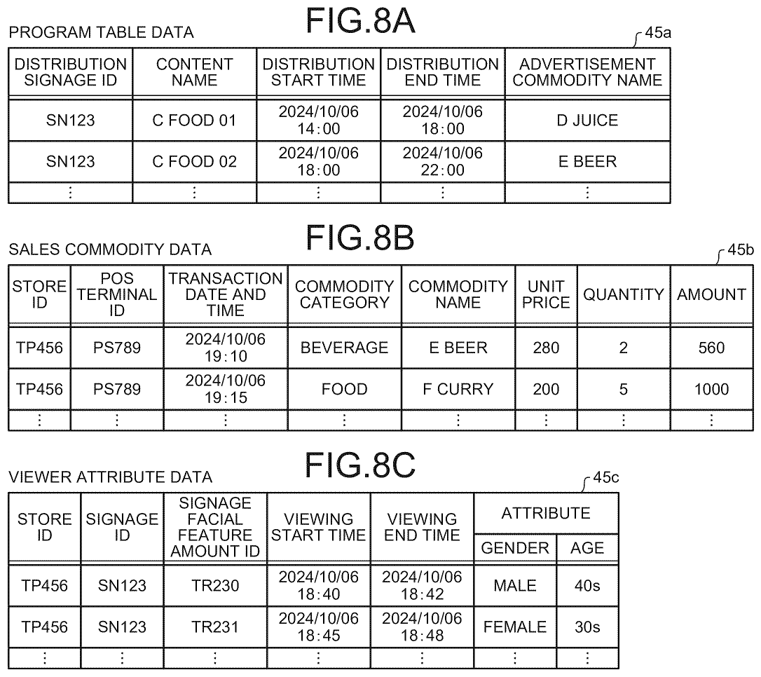

Next, an example of the data stored in the memory 45 of the information processing apparatus 40 shown in FIG. 7 will be described. FIGS. 8A to 8C, 9A to 9C, 10A and 10B, and FIG. 11 show examples of the program table data 45a, the sales commodity data 45b, the viewer attribute data 45c, the purchaser attribute data 45d, the comparison data 45e, the viewed commodity data 45f, the purchased commodity data 45g, the determination data 45h, and the analysis data 45i, respectively, shown in FIG. 7.

In the program table data 45a shown in FIG. 8A, the distribution signage ID “SN123” is associated with the state where the content name is “C food 01”, the distribution start time is “2024/10/06 14:00”, the distribution end time is “2024/10/06 18:00”, and the advertisement commodity name is “D juice”. The distribution signage ID “SN123” is also associated with the state where the content name is “C food 02”, the distribution start time is “2024/10/06 18:00”, the distribution end time is “2024/10/06 22:00”, and the advertisement commodity name is “E beer”.

In the sales commodity data 45b shown in FIG. 8B, the store ID “TP456” is associated with the state where the POS terminal ID is “PS789”, the transaction date and time is “2024/10/06 19:10”, the commodity category is “beverage”, the commodity name is “E beer”, the unit price is “280” yen, the quantity is “2” bottles, and the amount is “560” yen. The store ID “TP456” is also associated with the state where the POS terminal ID is “PS789”, the transaction date and time is “2024/10/06 19:15”, the commodity category is “food”, the commodity name is “F curry”, the unit price is “200” yen, the quantity is “5”, and the amount is “1000” yen.

In the viewer attribute data 45c shown in FIG. 8C, the store ID “TP456” is associated with the state where the signage ID is “SN123”, the signage facial feature amount ID is “TR230”, the viewing start time is “2024/10/06 18:40”, the viewing end time is “2024/10/06 18:42”, the gender as the attribute is “male”, and the age is “40s”.

In the viewer attribute data 45c, the store ID “TP456” is also associated with the state where the signage ID is “SN123”, the signage facial feature amount ID is “TR231”, the viewing start time is “2024/10/06 18:45”, the viewing end time is “2024/10/06 18:48”, the gender as the attribute is “female”, and the age is “30s”.

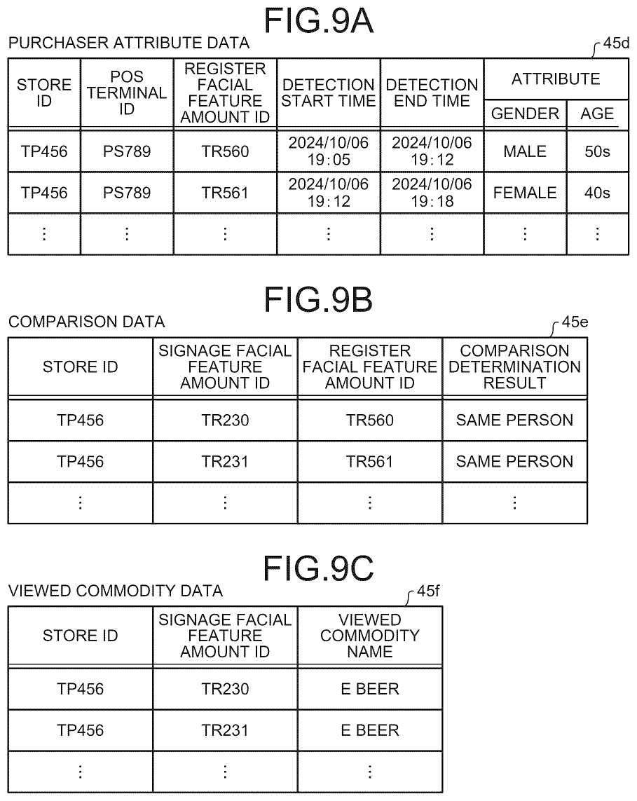

In the purchaser attribute data 45d shown in FIG. 9A, the store ID “TP456” is associated with the state where the POS terminal ID is “PS789”, the register facial feature amount ID is “TR560”, the detection start time is “2024/10/06 19:05”, the detection end time is “2024/10/06 19:12”, the gender as the attribute is “male”, and the age is “50s”.

In the purchaser attribute data 45d, the store ID “TP456” is also associated with the state where the POS terminal ID is “PS789”, the register facial feature amount ID is “TR561”, the detection start time is “2024/10/06 19:12”, the detection end time is “2024/10/06 19:18”, the gender as the attribute is “female”, and the age is “40s”.

In the comparison data 45e shown in FIG. 9B, the store ID “TP456” is associated with the state where the signage facial feature amount ID is “TR230”, the register facial feature amount ID is “TR560”, and the matching determination result is “same person”. The store ID “TP456” is also associated with the state where the signage facial feature amount ID is “TR231”, the register facial feature amount ID is “TR561”, and the matching determination result is “same person”.

In the viewed commodity data 45f shown in FIG. 9C, the store ID “TP456” is associated with the state where the signage facial feature amount ID is “TR230” and the viewed commodity name is “E beer”. The store ID “TP456” is also associated with the state where the signage facial feature amount ID is “TR231” and the viewed commodity name is “E beer”.

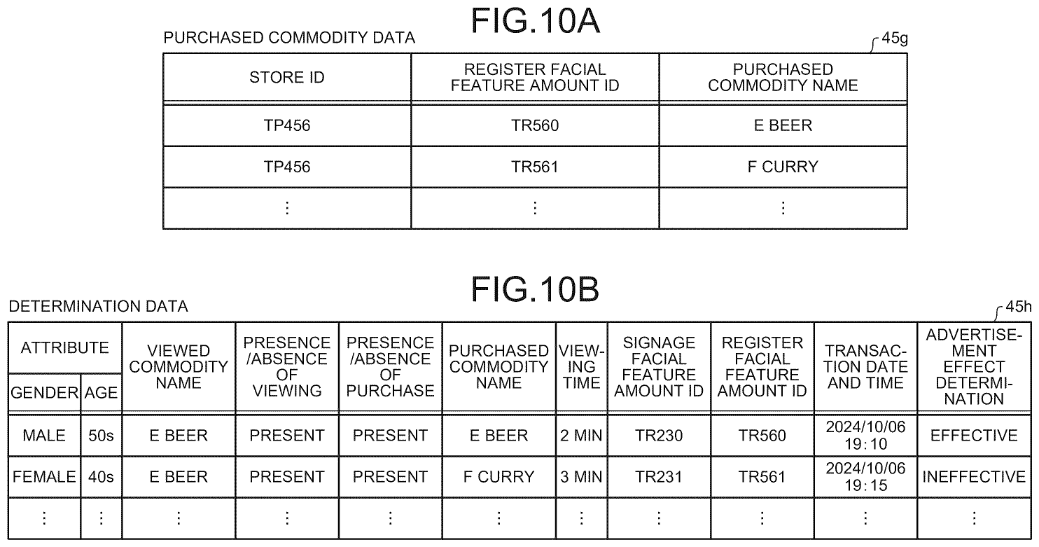

In the purchased commodity data 45g shown in FIG. 10A, the store ID “TP456” is associated with the state where the register facial feature amount ID is “TR560” and the purchased commodity name is “E beer”. The store ID “TP456” is also associated with the state where the register facial feature amount ID is “TR561” and the purchased commodity name is “F curry”.

In the determination data 45h shown in FIG. 10B, the gender “male” and the age “50s” as attributes are associated with the state where the viewed commodity name is “E beer”, the viewing presence/absence is “present”, the purchase presence/absence is “present”, the purchased commodity name is “E beer”, the viewing time is “two minutes”, the signage facial feature amount ID is “TR230”, the register facial feature amount ID is “TR560”, the transaction date and time is “2024/10/06 19:10”, and the advertisement effect determination is “effective”.

In the determination data 45h, the gender “female” and the age “40s” as attributes are associated with the state where the viewed commodity name is “E beer”, the viewing presence/absence is “presence”, the purchase presence/absence is “presence”, the purchased commodity name is “F curry”, the viewing time is “3 minutes”, the signage facial feature amount ID is “TR231”, the register facial feature amount ID is “TR561”, the transaction date and time is “2024/10/06 19:15”, and the advertisement effect determination is “ineffective”.

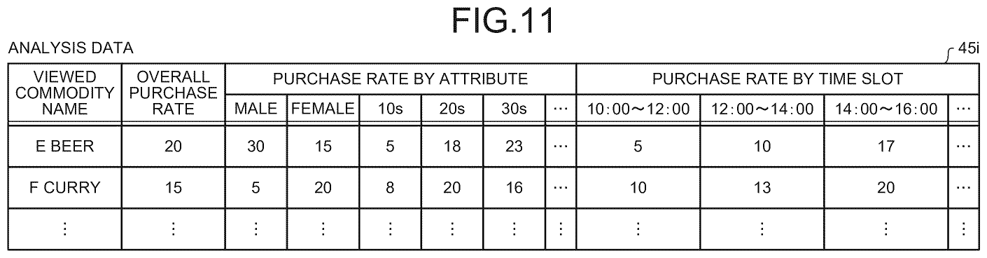

In the analysis data 45i shown in FIG. 11, the viewed commodity name “E beer” is associated with the state where the overall purchase rate is 20%, the purchase rate by attribute for male is 30%, the purchase rate by attribute for female is 15%, the purchase rate by attribute for teens is 5%, the purchase rate by attribute for those in their 20s is 18%, the purchase rate by attribute for those in their 30s is 23%, the purchase rate by time slot for 10:00-12:00 is 5%, the purchase rate by time slot for 12:00-14:00 is 10%, and the purchase rate by time slot for 14:00-16:00 is 17%.

In the analysis data 45i, the viewed commodity name “F curry” is associated with the state where the overall purchase rate is 15%, the purchase rate by attribute for male is 5 %, the purchase rate by attribute for female is 20%, the purchase rate by attribute for teens is 8%, the purchase rate by attribute for those in their 20s is 20%, the purchase rate by attribute for those in their 30s is 16%, the purchase rate by time slot for 10:00-12:00 is 10%, the purchase rate by time slot for 12:00-14:00 is 13%, and the purchase rate by time slot for 14:00-16:00 is 20%.

### Configuration of Advertisement Display 50

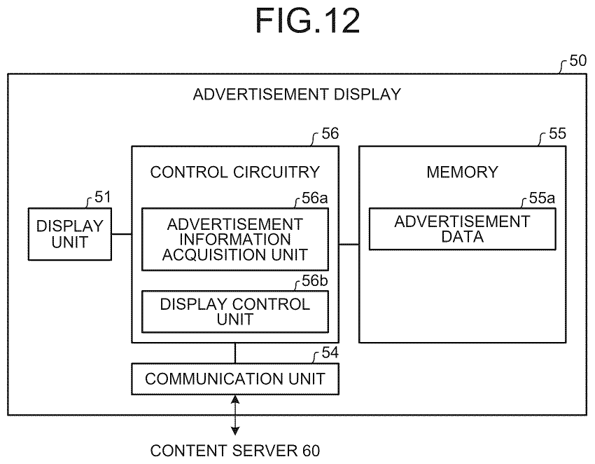

The configuration of the advertisement display 50 shown in FIG. 2 will be described. FIG. 12 is a function block diagram showing the configuration of the advertisement display 50 shown in FIG. 2. As shown in FIG. 12, the advertisement display 50 includes a display unit 51, a communication unit 54, a memory 55, and a control circuitry 56.

The display unit 51 is a display device such as a liquid crystal panel. The communication unit 54 is an interface unit for data communication with the content server 60 via the Internet.

The memory 55 is a storage device such as a hard disk device or a non-volatile memory, and stores advertisement data 55a therein. The advertisement data 55a is data including information for displaying advertisements. The advertisement data 55a includes a program table and advertisement images of commodity advertisements.

The control circuitry 56 performs overall control for the advertisement display 50. The control circuitry 56 includes an advertisement information acquisition unit 56a and a display control unit 56b. In actuality, programs for these units are loaded to a CPU and executed, whereby processes corresponding to the advertisement information acquisition unit 56a and the display control unit 56b are performed.

The advertisement information acquisition unit 56a is a processing unit that manages the advertisement data 55a. Upon receiving the advertisement information from the content server 60, the advertisement information acquisition unit 56a stores the advertisement information into the advertisement data 55a.

The display control unit 56b is a processing unit that controls advertisement display. The display control unit 56b displays advertisement images on the display unit 51, based on the program table in the advertisement data 55a.

### Procedures Relating to Advertisement Effect Determination

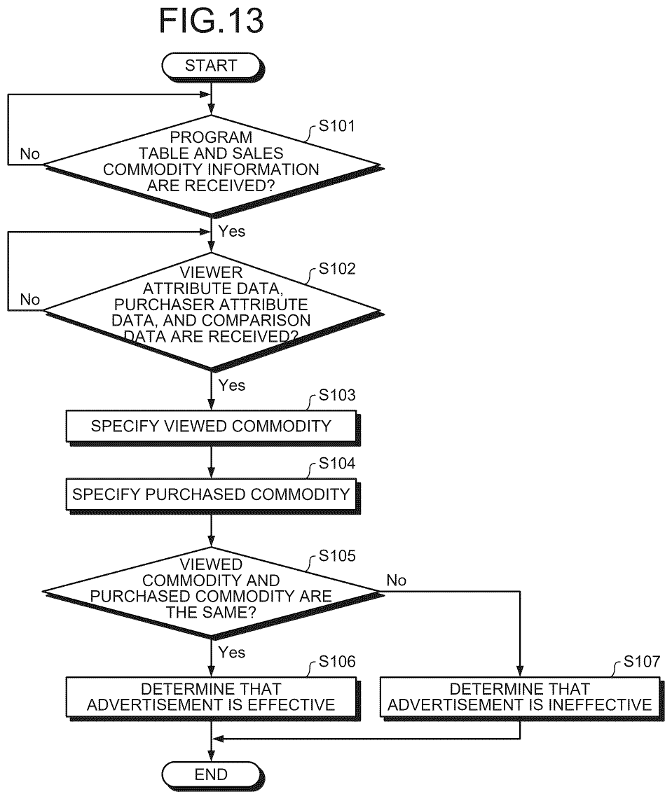

The procedures relating to advertisement effect determination will be described. FIG. 13 is a flowchart showing the procedures relating to the advertisement effect determination.

As shown in FIG. 13, upon receiving the program table from the content server 60 and the sales commodity information from the POS server 90 (step S101; Yes), the information processing apparatus 40 stores them into the program table data 45a and the sales commodity data 45b, respectively.

Upon receiving the viewer attribute data from the terminal device 10, and the purchaser attribute data and the comparison data from the terminal device 20 (step S102; Yes), the information processing apparatus 40 stores them into the viewer attribute data 45c, the purchaser attribute data 45d, and the comparison data 45e, respectively.

The information processing apparatus 40 specifies the viewed commodity, which is a commodity that was viewed by a customer through an advertisement, based on the viewer attribute data 45c and the program table data 45a (step S103). The information processing apparatus 40 specifies the purchased commodity, which is a commodity that was purchased by the customer, based on the purchaser attribute data 45d and the sales commodity data 45b (step S104).

If the specified viewed commodity and the specified purchased commodity are the same commodity (step S105; Yes), it is determined that the advertisement is effective (step S106). If the specified viewed commodity and the specified purchased commodity are different commodities (step S105; No), it is determined that the advertisement is ineffective (step S107), and the process is ended.

### Example of Hardware Configuration Relating to Information Processing Apparatus 40

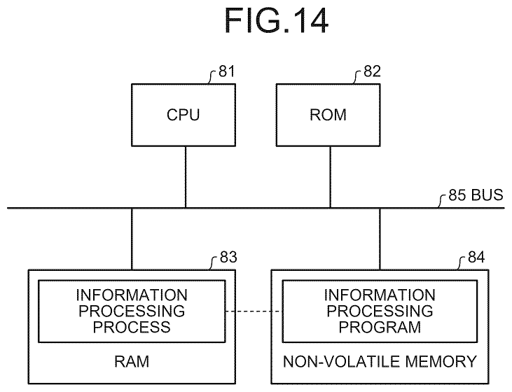

The correspondence between the information processing apparatus 40 and the main hardware configuration of a computer will be described. FIG. 14 shows an example of the hardware configuration relating to the information processing apparatus 40.

In general, a computer has a configuration in which a CPU 81, a ROM 82, a RAM 83, a non-volatile memory 84, and the like are connected with each other by a bus 85. A hard disk device may be provided instead of the non-volatile memory 84. For convenience of description, only a basic hardware configuration is shown in FIG. 14.

A program and the like necessary for activation of an operating system (hereinafter, simply referred to as “OS”) are stored in the ROM 82 or the non-volatile memory 84. When power is supplied, the CPU 81 reads the program for the OS from the ROM 82 or the non-volatile memory 84 and executes the program.

Meanwhile, various application programs to be executed on the OS are stored in the non-volatile memory 84. The CPU 81 executes an application program while using the RAM 83 as a main memory, whereby the process corresponding to the application is performed.

An information processing program for the information processing apparatus 40 is also stored in the non-volatile memory 84 or the like, as in the case of the other application programs. The CPU 81 loads and executes the program. In the case of the information processing apparatus 40, an information processing program includes routines corresponding to the program table acquisition unit 46a, the sales commodity information acquisition unit 46b, the viewer information acquisition unit 46c, the purchaser information acquisition unit 46d, the comparison information acquisition unit 46e, the viewed commodity specification unit 46f, the purchased commodity specification unit 46g, the determination unit 46h, and the analysis unit 46i shown in FIG. 7. The information processing program is stored in the non-volatile memory 84 or the like. The CPU 81 loads and executes the information processing program, whereby an information processing process corresponding to the program table acquisition unit 46a, the sales commodity information acquisition unit 46b, the viewer information acquisition unit 46c, the purchaser information acquisition unit 46d, the comparison information acquisition unit 46e, the viewed commodity specification unit 46f, the purchased commodity specification unit 46g, the determination unit 46h, and the analysis unit 46i is generated.

As described above, in the information processing system, a facial feature amount is extracted from an image obtained by capturing, by using the external imaging device, a customer who has viewed an advertisement displayed on the advertisement display, another facial feature amount is extracted from another image obtained by capturing, by using another external imaging device, a customer who has purchased a commodity, and the facial feature amounts are compared with each other. If the customers are determined to be the same person and the commodity of the viewed advertisement is the same as the purchased commodity, it is determined that the displayed advertisement is effective. Therefore, when the customer who views a commodity advertisement displayed on the display installed in the store is captured by the external imaging device, the purchase status of the corresponding commodity by the viewer of the advertisement can be grasped.

In the above embodiment, as the analysis for the advertisement effect, the purchase rate by attribute and the purchase rate by viewing time slot are calculated for each purchased commodity. However, the present disclosure is not limited thereto. The viewing rate for each content or commodity in the advertisement can be calculated by separately detecting persons who viewed an advertisement displayed on the advertisement display and persons who did not view the advertisement. In this case, the base number for the viewing rate is the number of persons who passed through a predetermined area near the advertisement display. In this case, the viewing rate may be calculated by attribute, by time slot on the advertisement viewing date, by viewing date, by viewing day of the week, or by viewing month. Moreover, the purchase rate of the advertised commodity may be calculated for customers who did not view the advertisement. In this case, the viewing rate may be calculated by attribute or by viewing time slot. A value obtained by subtracting the purchase rate of the advertised commodity by the persons who did not view the advertisement from the purchase rate of the advertised commodity by the persons who viewed the advertisement may be used as the advertisement effect.

In the above embodiment, as the analysis for the advertisement effect, the purchase rate by attribute and the purchase rate by viewing time slot are calculated for each purchased commodity. However, the present disclosure is not limited thereto. Persons who viewed the advertisement displayed on the advertisement display and persons who did not view the advertisement may be detected separately, and the facial feature amounts of customers may be acquired by a camera installed on a commodity sales floor, whereby the stop-by rate at the sales floor may be calculated for the customers who viewed the advertisement and the customers who did not view the advertisement.

For example, a master table in which cameras installed on the sales floor are linked with displayed commodities is stored in a higher-order device in advance, and a displayed commodity is specified from the ID of a camera that has acquired the facial feature amount of a customer, whereby it is determined that the customer stopped by the sales floor of the displayed commodity. Furthermore, a master table in which cameras installed on the sales floor are linked with display shelves for each display shelf type is stored in the higher-order device in advance, and a display shelf and a display shelf type (such as alcoholic beverage display shelf) are specified from the ID of a camera that has acquired the facial feature amount of a customer, whereby it is determined that the customer stopped by the sales floor with the display shelf of the specific type. Moreover, a displayed commodity may be specified by performing object detection using a captured image to determine that the customer stopped by the sales floor of the displayed commodity. By capturing a face image of a customer with a camera, detecting an action of holding a commodity with hands and returning the commodity, and specifying the held commodity through object detection, it is possible to determine whether the customer was interested in the viewed commodity.

The base number for the stop-by rate is the number of persons who viewed the advertisement on the advertisement display. The stop-by rate may be calculated by attribute, by time slot of the advertisement viewing date, by viewing date, by viewing day of the week, or by viewing month. The base number for the attribute-based stop-by rate is the number of viewers of a specific age or a specific gender.

The purchase rate of an advertised commodity for the customers who did not view the advertisement may be calculated by stop-by time slot. In this case, the base number for the purchase rate by stop-by time slot is the number of persons who stopped by the sales floor within the stop-by time slot among the persons who did not view the advertisement. A value calculated by subtracting the stop-by rate at the sales floor by the persons who did not view the advertisement from the stop-by rate at the sales floor by the persons who viewed the advertisement may be used as the advertisement effect.

In the above embodiment, the facial feature amount of the viewer and the facial feature amount of the purchaser are compared with each other, and only when the viewer and the purchaser are determined to be the same person, the information processing apparatus acquires the comparison data. However, the present disclosure is not limited thereto. Even when the viewer and the purchaser are determined to be different persons through the comparison of the facial feature amounts thereof, the information processing apparatus may acquire the comparison data.

In the above embodiment, the program table includes both the content name and the advertisement commodity name. However, the present disclosure is not limited thereto. If the content name and the advertisement commodity name are treated as the same name, only the content name may be included in the program table.

In the above embodiment, the cameras are externally disposed near the advertisement display and the POS terminal. However, the present disclosure is not limited thereto. The cameras may be built in the advertisement display and the POS terminal.

In the above embodiment, when the viewed commodity and the purchased commodity are the same commodity, it is determined that the advertisement is effective. However, the present disclosure is not limited thereto. Even if a commodity similar to the viewed commodity is purchased, the advertisement may be determined to be effective. For example, if the customer bought beer from “DEF brewery” after viewing an advertisement of “ABC brewery”, it can be determined that the advertisement is effective in the broader category of “beer”. If the customer bought “B beer” that is a commodity of “ABC brewery” after viewing an advertisement of “A beer” of “ABC brewery”, it can be determined that the advertisement is effective. Also, if the customer bought an alcoholic beverage commodity after viewing an advertisement of “ABC brewery”, it can be determined that the advertisement is effective.

In the above embodiment, based on the face direction and the line of sight of a person present near the advertisement display, whether this person is viewing an advertisement image is determined, and the facial feature amount of this person is acquired. However, the present disclosure is not limited thereto. A person who stays near the advertisement display for a certain time may be detected, and the facial feature amount of this person may be acquired. A predetermined time period is set in advance for detecting that the person stays near the advertisement display. Alternatively, it may be determined that the person stays near the advertisement display if it is detected that the person has momentarily stopped near the advertisement display. A person who has approached within a predetermined distance of the advertisement display may be detected, and the facial feature amount of this person may be acquired.

In the above embodiment, based on the face direction and the line of sight of a person present near the advertisement display, whether this person is viewing an advertisement image is determined. However, the present disclosure is not limited thereto. The method for determining whether a person present near the advertisement display is viewing an advertisement image may be determined based on at least one of the face direction, line of sight, and the stay time of this person.

In the above embodiment, the program table as a schedule of advertisement display is acquired from the content server, and a commodity that is scheduled to be advertised on the program table is specified as a viewed commodity, based on the viewing time of a person who viewed the advertisement display. However, the present disclosure is not limited thereto. An advertisement display result table indicating the results of displayed commodity advertisements from the content server, and a commodity described on the advertisement display result table may be identified as a viewed commodity, based on the viewing time (clock time) of a person who viewed the advertisement display.

In the above embodiment, the POS server notifies the information processing apparatus of the sales commodity information acquired from the POS terminal. However, the present disclosure is not limited thereto. The terminal device disposed near the POS terminal may notify the information processing apparatus of the sales commodity information acquired from the POS terminal.

In the above embodiment, whether customers are the same person is determined by using the facial feature amounts of the customers. However, the present disclosure is not limited thereto. This determination may be performed by using the fingerprint, the iris of the eye, the capillaries of the eye, the voiceprint, etc. of each customer.

In the above embodiment, analysis is performed according to the gender and the age (generation) as the customer attributes. However, the present disclosure is not limited thereto. Analysis may also be performed according to at least one of the gender, the age (generation), the physique, and the nationality (Japanese or non-Japanese, for example), as customer attributes.

The advertisement fee for signage is generally a fixed fee; however, since the advertisement effect can be calculated, it is possible to charge part or all of the fee according to the effect. Alternatively, the fee may be charged according to the purchase rate of the viewed commodity, the viewing rate, or the sales floor stop-by rate.

The base number of the purchase rate may be the number of viewers who viewed a specific commodity advertisement, or the number of viewers who viewed a specific content that advertises a plurality of commodities. In the latter case, it may be determined that the advertisement is effective if at least one of the plurality of commodities being advertised in the content is purchased.

In the above embodiment, the viewing rate of a commodity advertisement is described as an evaluation item for advertisement effect. However, the present disclosure is not limited thereto. The number of viewers of a commodity advertisement may be used.

An information processing apparatus according to one aspect of the present disclosure includes: a person information acquisition unit configured to acquire person information including feature information of a person who is present near a display for displaying a commodity advertisement and satisfies a predetermined condition and information on a time at which the person is present near the display device; a purchaser information acquisition unit configured to acquire purchaser information including feature information of a purchaser who purchases a commodity and information on a purchase time at which a purchase action of the purchaser is detected; an association unit configured to compare the feature information of the person with the feature information of the purchaser, and associate the person information with the purchaser information of the same person; a memory configured to store therein information on a display time for each commodity advertisement, at which the commodity advertisement is displayed on the display; a viewed commodity specification unit configured to specify a viewed commodity whose commodity advertisement is presumed to be viewed by the person, based on the person information and the display time; a commodity sales information acquisition unit configured to acquire commodity sales information including a sales commodity and sales time; a purchased commodity specification unit configured to specify a commodity purchased by the purchaser, based on the purchaser information and the commodity sales information; and a determination unit configured to specify the purchased commodity and the viewed commodity corresponding to the same person, based on correspondence between the person information and the purchaser information, and determine whether the person has purchased the viewed commodity, based on a result of comparison between the viewed commodity and the purchased commodity.

In the above configuration, the viewed commodity specification unit specifies, as the viewed commodity, a commodity whose commodity advertisement is displayed on the display at the display time corresponding to the time at which the person is present near the display.

In the above configuration, the purchased commodity specification unit specifies the sales time corresponding to the purchase time of the purchased commodity, and specifies, as the purchased commodity, the sales commodity sold at the specified sales time.

In the above configuration, the predetermined condition is a condition to determine whether the person present near the display is presumed to be a viewer viewing the commodity advertisement on the display, based on at least one of the person's face direction, line of sight, and stay time.

In the above configuration, the information processing apparatus further includes: a first imaging device disposed near the display; a second imaging device disposed near a sales terminal; a first edge terminal communicably connected to the first imaging device, and configured to extract, as the feature information of the person, a first facial feature amount of a face image of the person captured by the first imaging device; and a second edge terminal communicably connected to the second imaging device, and configured to extract, as the feature information of the purchaser, a second facial feature amount of a face image of the purchaser captured by the second imaging device, wherein the first edge terminal and the second edge terminal cooperate to perform comparison between the first facial feature amount and the second facial feature amount, so that the association unit associates the person information with the purchaser information of the same person.

An information processing apparatus according to one aspect of the present disclosure comprising: a person information acquisition unit configured to acquire person information including feature information of a person who is present near a display for displaying a commodity advertisement and satisfies a predetermined condition and information on a time at which the person is present near the display; a purchaser information acquisition unit configured to acquire purchaser information including feature information of a purchaser who purchases a commodity and commodity sales information including a sales commodity; an association unit configured to compare the feature information of the person with the feature information of the purchaser, and associate the person information with the commodity sales information of the same person; a memory configured to store therein information on a display time for each commodity advertisement, at which the commodity advertisement is displayed on the display; a viewed commodity specification unit configured to specify a viewed commodity whose commodity advertisement is presumed to be viewed by the person, based on the person information and the display time; and a determination unit configured to specify the sales commodity and the viewed commodity corresponding to the same person, based on correspondence between the person information and the commodity sales information, and determine whether the person has purchased the viewed commodity, based on a result of comparison between the viewed commodity and the sales commodity.

An information processing system according to one aspect of the present disclosure comprising: a person information acquisition unit configured to acquire person information including feature information of a person who is present near a display for displaying a commodity advertisement and satisfies a predetermined condition and information on a time at which the person is present near the display; a purchaser information acquisition unit configured to acquire purchaser information including feature information of a purchaser who purchases a commodity and information on a purchase time at which a purchase action of the purchaser is detected; an association unit configured to compare the feature information of the person with the feature information of the purchaser, and associate the person information with the purchaser information of the same person; a memory configured to store therein information on a display time for each commodity advertisement, at which the commodity advertisement is displayed on the display; a viewed commodity specification unit configured to specify a viewed commodity whose commodity advertisement is presumed to be viewed by the person, based on the person information and the display time; a commodity sales information acquisition unit configured to acquire commodity sales information including a sales commodity and sales time; a purchased commodity specification unit configured to specify a commodity purchased by the purchaser, based on the purchaser information and the commodity sales information; and a determination unit configured to specify the purchased commodity and the viewed commodity corresponding to the same person, based on correspondence between the person information and the purchaser information, and determine whether the person has purchased the viewed commodity, based on a result of comparison between the viewed commodity and the purchased commodity.

An information processing system according to one aspect of the present disclosure comprising: a person information acquisition unit configured to acquire person information including feature information of a person who is present near a display for displaying a commodity advertisement and satisfies a predetermined condition and information on a time at which the person is present near the display; a purchaser information acquisition unit configured to acquire purchaser information including feature information of a purchaser who purchases a commodity and commodity sales information including a sales commodity; an association unit configured to compare the feature information of the person with the feature information of the purchaser, and associate the person information with the commodity sales information of the same person; a memory configured to store therein information on a display time for each commodity advertisement, at which the commodity advertisement is displayed on the display; a viewed commodity specification unit configured to specify a viewed commodity whose commodity advertisement is presumed to be viewed by the person, based on the person information and the display time; and a determination unit configured to specify the sales commodity and the viewed commodity corresponding to the same person, based on correspondence between the person information and the commodity sales information, and determine whether the person has purchased the viewed commodity, based on a result of comparison between the viewed commodity and the sales commodity.

An information processing method according to one aspect of the present disclosure comprising: acquiring person information including feature information of a person who is present near a display for displaying a commodity advertisement and satisfies a predetermined condition and information on a time at which the person is present near the display; acquiring purchaser information including feature information of a purchaser who purchases a commodity and information on a purchase time at which a purchase action of the purchaser is detected; comparing the feature information of the person with the feature information of the purchaser to associate the person information with the purchaser information of the same person; storing, in a memory, information on a display time for each commodity advertisement, at which the commodity advertisement is displayed on the display; specifying a viewed commodity whose commodity advertisement is presumed to be viewed by the person, based on the person information and the display time; acquiring commodity sales information including a sales commodity and sales time; specifying a commodity purchased by the purchaser, based on the purchaser information and the commodity sales information; and specifying the purchased commodity and the viewed commodity corresponding to the same person, based on correspondence between the person information and the purchaser information to determine whether the person has purchased the viewed commodity, based on a result of comparison between the viewed commodity and the purchased commodity.

An information processing method according to one aspect of the present disclosure comprising: acquiring person information including feature information of a person who is present near a display for displaying a commodity advertisement and satisfies a predetermined condition and information on a time at which the person is present near the display; acquiring purchaser information including feature information of a purchaser who purchases a commodity and commodity sales information including a sales commodity; comparing the feature information of the person with the feature information of the purchaser to associate the person information with the commodity sales information of the same person; storing, in a memory, information on a display time for each commodity advertisement, at which the commodity advertisement is displayed on the display; specifying a viewed commodity whose commodity advertisement is presumed to be viewed by the person, based on the person information and the display time; and specifying the purchased commodity and the sales commodity corresponding to the same person, based on correspondence between the person information and the commodity sales information to determine whether the person has purchased the viewed commodity, based on a result of comparison between the viewed commodity and the sales commodity.

A computer program product for information processing according to one aspect of the present disclosure is embodied in a non-transitory computer-readable medium, and the program causes a computer to execute: acquiring person information including feature information of a person who is present near a display for displaying a commodity advertisement and satisfies a predetermined condition and information on a time at which the person is present near the display; acquiring purchaser information including feature information of a purchaser who purchases a commodity and information on a purchase time at which a purchase action of the purchaser is detected; comparing the feature information of the person with the feature information of the purchaser to associate the person information with the purchaser information of the same person; storing, in a memory, information on a display time for each commodity advertisement, at which the commodity advertisement is displayed on the display; specifying a viewed commodity whose commodity advertisement is presumed to be viewed by the person, based on the person information and the display time; acquiring commodity sales information including a sales commodity and sales time; specifying a commodity purchased by the purchaser, based on the purchaser information and the commodity sales information; and specifying the purchased commodity and the viewed commodity corresponding to the same person, based on correspondence between the person information and the purchaser information to determine whether the person has purchased the viewed commodity, based on a result of comparison between the viewed commodity and the purchased commodity.

A computer program product for information processing according to one aspect of the present disclosure is embodied in a non-transitory computer-readable medium, and the program causes a computer to execute: acquiring person information including feature information of a person who is present near a display for displaying a commodity advertisement and satisfies a predetermined condition and information on a time at which the person is present near the display; acquiring purchaser information including feature information of a purchaser who purchases a commodity and commodity sales information including a sales commodity; comparing the feature information of the person with the feature information of the purchaser to associate the person information with the commodity sales information of the same person; storing, in a memory, information on a display time for each commodity advertisement, at which the commodity advertisement is displayed on the display; specifying a viewed commodity whose commodity advertisement is presumed to be viewed by the person, based on the person information and the display time; and specifying the purchased commodity and the sales commodity corresponding to the same person, based on correspondence between the person information and the commodity sales information to determine whether the person has purchased the viewed commodity, based on a result of comparison between the viewed commodity and the sales commodity.

According to the present disclosure, when a customer who views an advertisement of a commodity displayed on a display installed in a store can be captured by using an external imaging device, the purchase status of the corresponding commodity by the viewer of the advertisement can be grasped.

The illustrated components in the above embodiment are conceptually functional constituent elements, and thus may not necessarily be configured as physical constituent elements, as illustrated in the drawings. That is, distributed or integrated forms of each device are not limited to the forms illustrated in the drawings, and all or some of the forms may be distributed or integrated functionally or physically in any unit depending on various loads, use statuses, or the like. For example, the terminal device disposed near the advertisement display and the terminal device disposed near the POS terminal may be integrated as a single device.

What is claimed is:

1. An information processing apparatus comprising:
a person information acquisition unit configured to acquire person information including feature information of a person who is present near a display for displaying a commodity advertisement and satisfies a predetermined condition and information on a time at which the person is present near the display;
a purchaser information acquisition unit configured to acquire purchaser information including feature information of a purchaser who purchases a commodity and information on a purchase time at which a purchase action of the purchaser is detected;
an association unit configured to compare the feature information of the person with the feature information of the purchaser, and associate the person information with the purchaser information of the same person;
a memory configured to store therein information on a display time for each commodity advertisement, at which the commodity advertisement is displayed on the display;
a viewed commodity specification unit configured to specify a viewed commodity whose commodity advertisement is presumed to be viewed by the person, based on the person information and the display time;
a commodity sales information acquisition unit configured to acquire commodity sales information including a sales commodity and sales time;
a purchased commodity specification unit configured to specify a commodity purchased by the purchaser, based on the purchaser information and the commodity sales information; and
a determination unit configured to specify the purchased commodity and the viewed commodity corresponding to the same person, based on correspondence between the person information and the purchaser information, and determine whether the person has purchased the viewed commodity, based on a result of comparison between the viewed commodity and the purchased commodity.

2. The information processing apparatus according to claim 1, wherein
the viewed commodity specification unit specifies, as the viewed commodity, a commodity whose commodity advertisement is displayed on the display at the display time corresponding to the time at which the person is present near the display.

3. The information processing apparatus according to claim 1, wherein
the purchased commodity specification unit specifies the sales time corresponding to the purchase time of the purchased commodity, and specifies, as the purchased commodity, the sales commodity sold at the specified sales time.

4. The information processing apparatus according to claim 1, wherein
the predetermined condition is a condition to determine whether the person present near the display is presumed to be a viewer viewing the commodity advertisement on the display, based on at least one of the person's face direction, line of sight, and stay time.

5. The information processing apparatus according to claim 1, further comprising:
a first imaging device disposed near the display;
a second imaging device disposed near a sales terminal;
a first edge terminal communicably connected to the first imaging device, and configured to extract, as the feature information of the person, a first facial feature amount of a face image of the person captured by the first imaging device; and
a second edge terminal communicably connected to the second imaging device, and configured to extract, as the feature information of the purchaser, a second facial feature amount of a face image of the purchaser captured by the second imaging device, wherein
the first edge terminal and the second edge terminal cooperate to perform comparison between the first facial feature amount and the second facial feature amount, so that the association unit associates the person information with the purchaser information of the same person.

6. An information processing system comprising:
a person information acquisition unit configured to acquire person information including feature information of a person who is present near a display for displaying a commodity advertisement and satisfies a predetermined condition and information on a time at which the person is present near the display;
a purchaser information acquisition unit configured to acquire purchaser information including feature information of a purchaser who purchases a commodity and information on a purchase time at which a purchase action of the purchaser is detected;
an association unit configured to compare the feature information of the person with the feature information of the purchaser, and associate the person information with the purchaser information of the same person;
a memory configured to store therein information on a display time for each commodity advertisement, at which the commodity advertisement is displayed on the display;
a viewed commodity specification unit configured to specify a viewed commodity whose commodity advertisement is presumed to be viewed by the person, based on the person information and the display time;
a commodity sales information acquisition unit configured to acquire commodity sales information including a sales commodity and sales time;
a purchased commodity specification unit configured to specify a commodity purchased by the purchaser, based on the purchaser information and the commodity sales information; and
a determination unit configured to specify the purchased commodity and the viewed commodity corresponding to the same person, based on correspondence between the person information and the purchaser information, and determine whether the person has purchased the viewed commodity, based on a result of comparison between the viewed commodity and the purchased commodity.

7. An information processing method comprising:
acquiring person information including feature information of a person who is present near a display for displaying a commodity advertisement and satisfies a predetermined condition and information on a time at which the person is present near the display;
acquiring purchaser information including feature information of a purchaser who purchases a commodity and information on a purchase time at which a purchase action of the purchaser is detected;
comparing the feature information of the person with the feature information of the purchaser to associate the person information with the purchaser information of the same person;
storing, in a memory, information on a display time for each commodity advertisement, at which the commodity advertisement is displayed on the display;
specifying a viewed commodity whose commodity advertisement is presumed to be viewed by the person, based on the person information and the display time;
acquiring commodity sales information including a sales commodity and sales time;
specifying a commodity purchased by the purchaser, based on the purchaser information and the commodity sales information; and
specifying the purchased commodity and the viewed commodity corresponding to the same person, based on correspondence between the person information and the purchaser information to determine whether the person has purchased the viewed commodity, based on a result of comparison between the viewed commodity and the purchased commodity.

8. A computer program product for information processing, embodied in a non-transitory computer-readable medium, the program causing a computer to execute:
acquiring person information including feature information of a person who is present near a display for displaying a commodity advertisement and satisfies a predetermined condition and information on a time at which the person is present near the display;
acquiring purchaser information including feature information of a purchaser who purchases a commodity and information on a purchase time at which a purchase action of the purchaser is detected;
comparing the feature information of the person with the feature information of the purchaser to associate the person information with the purchaser information of the same person;
storing, in a memory, information on a display time for each commodity advertisement, at which the commodity advertisement is displayed on the display;
specifying a viewed commodity whose commodity advertisement is presumed to be viewed by the person, based on the person information and the display time;
acquiring commodity sales information including a sales commodity and sales time;
specifying a commodity purchased by the purchaser, based on the purchaser information and the commodity sales information; and
specifying the purchased commodity and the viewed commodity corresponding to the same person, based on correspondence between the person information and the purchaser information to determine whether the person has purchased the viewed commodity, based on a result of comparison between the viewed commodity and the purchased commodity.
